(19) United States
(12) Patent Application Publication
(10) Pub. No.: US 2022/0299127 A1
(43) Pub. Date: Sep. 22, 2022

(54) SOLENOID VALVE

(71) Applicant: Schrader-Bridgeport International, Inc., Altavista, VA (US)

(72) Inventor: Gregory D. Trulear, Forest, VA (US)

(73) Assignee: Schrader-Bridgeport International, Inc., Altavista, VA (US)

(21) Appl. No.: 17/698,237

(22) Filed: Mar. 18, 2022

Related U.S. Application Data
(60) Provisional application No. 63/162,858, filed on Mar. 18, 2021.

(51) Int. Cl. F16K 31/06

(52) U.S. Cl. CPC F16K 31/0658; F16K 31/0675

(57) ABSTRACT

A valve may include an inlet, an outlet, and a plunger located at least partially within a central passage of the valve, where the plunger is movable between an open state and a closed state, and where the inlet is in fluid communication with the outlet when the plunger is in the open state, and where the plunger prevents fluid communication between the inlet and the outlet when the plunger is in the closed state. A solenoid may have a winding that surrounds the central passage of the valve and at least partially surrounds the plunger. The plunger may have a magnetizable material that experiences a linear force extending along the central passage of the valve when the winding of the solenoid receives a current.

### RELATED APPLICATION

This application claims the benefit of U.S. Provisional Application No. 63/162,858, filed Mar. 18, 2021, which is hereby incorporated by reference in its entirety.

### TECHNICAL FIELD

The present disclosure generally relates to valves and valve components that regulate the flow of fluid in at least one direction, such as components for a check valve or charge valve included in an air conditioning system.

### BACKGROUND

Check valves, such as those used to connect a refrigerant source to an air conditioning system, are designed to prevent backward flow of a liquid. For example, when coupled to a refrigerant charging line, a check valve may allow flow of the refrigerant in only one direction. Typically, check valves have a valve body that defines an axially-oriented passageway (or “central passage”). An annular valve seat is disposed around the passageway, and a spring-loaded valve pin is mounted inside the central passage. The valve pin seats against the valve seat to prevent flow through the central passage when the check valve pin is closed, and it is spaced from the valve seat when the check valve is open to permit flow through the central passage.

The embodiments described herein are related to improved valve structures (and related methods).

### BRIEF DESCRIPTION OF THE DRAWINGS

The embodiments of the present disclosure may be better understood with reference to the following drawings and description. The components in the figures are not necessarily to scale, with emphasis instead being placed upon illustrating the principles of the present disclosure. Moreover, in the figures, like reference numerals designate similar or identical features.

FIG. 1 shows a perspective view of a valve having a solenoid in accordance with certain aspects of the present disclosure.

FIG. 2 shows a section view of the valve from FIG. 1.

FIG. 3 shows a perspective view of a plunger, including an outer body surrounding a valve core, for use in a valve in accordance with certain aspects of the present disclosure.

FIG. 4 shows a perspective view of the valve core from FIG. 3 in isolation.

### DETAILED DESCRIPTION

Various aspects are described below with reference to the drawings in which like elements generally are identified by like numerals. The relationship and functioning of the various elements of the aspects may be better understood by reference to the following detailed description. However, aspects are not limited to those illustrated in the drawings or explicitly described below. It also should be understood that the drawings are not necessarily to scale, and in certain instances, details may have been omitted that are not necessary for an understanding of aspects disclosed herein, such as conventional fabrication and assembly.

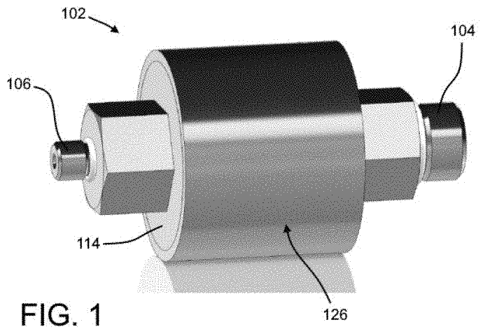

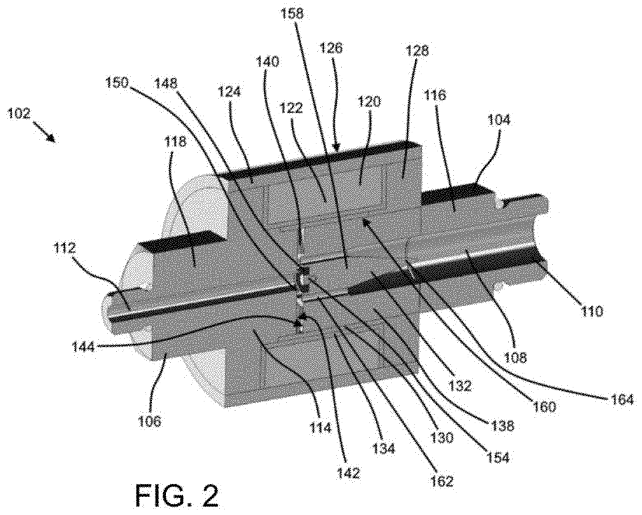

FIGS. 1-2 respectively show a perspective view and a sectional view of a valve 102. In this disclosure, the valve 102 is described as being used with an air conditioning system (“AC system”), particularly for providing communication between a charged refrigerant source and the tubing forming the primary refrigeration cycle. The valve 102 may be used for any other suitable application, particularly those where single-direction flow of a fluid (i.e., liquid or gas) is desired.

In the depicted embodiment of FIGS. 1-2, the valve 102 includes a first side 104 designed to couple to the refrigerant source and a second side 106 designed to couple to the refrigeration cycle. During normal operation, refrigerant may flow into the first side 104, through a central passage 108, and out of the second side 106 (and/or vice versa). Certain features of the valve 102 that may be included are described in U.S. patent application Ser. No. 16/540,297, filed Aug. 14, 2019, which is hereby incorporated by reference in its entirety.

As shown in FIG. 2, the valve 102 includes the inlet 110 on the first side 104 and an outlet on the second side 106. A valve body 114 may generally form the inlet 110 and the outlet 112. While it is contemplated that the valve body 114 may be a single unitary piece, the depicted valve body 114 includes certain components attached together, in particular a first body portion 116 forming the inlet 110 and a second body portion 118 forming the outlet. As discussed in more detail below, the valve body 114 may be attached to (or integral with) the winding 122 of a solenoid 120. A cylindrical solenoid cover 124 may generally surround a middle portion of the valve body 114 and may define a portion of the exterior surface 126 of the valve 102. Other optional components may additionally or alternatively be included, such as the depicted third body portion 128 for facilitating attachment of the solenoid winding 122 (and perhaps providing an access point for component installation), a sleeve 130 for separating certain solenoid components from the central passage 108 of the valve 102, etc.

The solenoid 120 may control the position of a plunger 132 within the central passage 108 of the valve. The winding 122 of the solenoid 120, which may include a wire coil, may be fixed relative to the valve body 114. For example, the valve body 114 may include a cylindrical cavity for receiving a bobbin 134 of the solenoid 120 which holds the solenoid's winding 122. The armature/plunger of the solenoid, which may include a magnetizable material (e.g., a ferrous metal), may be included in the plunger 132, such as in an outer body 138 of the plunger 132 or another plunger portion. Thus, when the winding 122 receives an electric current, which may be referred to as being “powered” or turned “on” in this disclosure, the plunger 132 may experience a linear force due to the formation of a magnetic field.

As a result of this structure, operation of the solenoid 120 may cause the plunger 132 to move to open or close the valve 102 when it receives an electric current. In particular, the plunger 132 may be movable between an open state (shown in FIG. 1) and a closed state (now shown). For example, as shown in FIG. 1, the inlet 110 is in fluid communication with the outlet 112 when the plunger 132 is in the open state. By contrast, the plunger 132 prevents fluid communication between the inlet 110 and the outlet 112 when the plunger is in the closed state.

A spring 140 may be coupled to the plunger 132 to cause the plunger 132 to move into at least one of the open state and the closed state when the solenoid is off. In the depicted embodiment, for example, the spring 140 causes the plunger 132 to move into the open state when the solenoid 120 is unpowered. Thus, when the solenoid 120 is off, the valve is open. Advantageously, this structure may ensure the valve remains open if the system loses power, which may be a safety feature in certain applications. In other embodiments, the spring 140 may cause the plunger 132 to move into the closed state when the solenoid 120 is unpowered, which may be advantageous when it is desirable for the valve 102 to remain closed by default.

The spring 140 may be any suitable device for providing force on the plunger 132 (e.g., relative to the valve body 114) when the solenoid is unpowered. Without limitation, the spring may include one or more of the following: a tension spring, compression spring, torsion spring, spiral spring, disc or Belleville spring, helical compression or extension spring, conical spring, etc. In the depicted embodiment, the spring 140 includes a washer spring that is located between a first spring surface 142 formed by the valve body 114, and therefore fixed to at least one of the inlet 110 and the outlet 112, and a second spring surface 144 fixed to the plunger 132.

In the depicted embodiment, providing power to the solenoid 120 causes the valve 102 to open such that a fluid may flow from the inlet 110 to the outlet 112. In particular, powering the solenoid 120 places a force on an armature, which in this case is a portion of the plunger 132 (i.e., the outer body 138). This solenoid-provided force is sufficient to overcome the spring force caused by compression of the spring 140. Thus, the plunger 132 moves towards the outlet such that a seal occurs (which is discussed in more detail below). In embodiments where the default state is “closed,” the solenoid 120 may overcome a spring force such that the plunger 132 moves to an open position when the solenoid is turned on.

When the valve 102 is closed, the interruption of fluid communication between the inlet 110 and the outlet 112 may be caused by contact between a compliant seal 148 and a seat surface 150. The seal 148 may be any suitable structure, and in this depicted instance, it is cut rubber sheet portion. The seat surface 150 may be included on a protrusion from the valve body 114, as shown, but this is optional. Alternatively, the seat surface 150 may simply be a flat surface that is continuous with the first spring surface 142, for example. In exemplary embodiments, the seat surface 150 may be integral with at least a portion of the valve body 114 such that it is the same material as at least that portion of the valve body 114. Alternatively, the seat surface 150 may be an attachment and/or otherwise may have a material that is different from the adjacent portions of the valve body 114.

The seal 148 may be secured to the plunger 132, as shown. In the depicted embodiment, a pin 154 secures the compliant seal 148 to the plunger 132, which may be advantageous since the compliant seal 148 can be changed easily via removal and reinsertion of the plunger 132. However, it is also contemplated that the seal 148 may be secured to the valve body 114 instead, and thus the seat surface 150 may be attached to (or a portion of) the plunger 132.

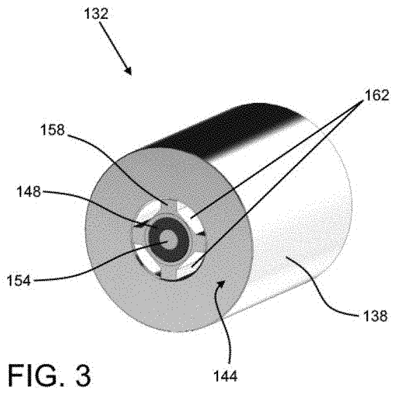

The plunger 132, which is shown in isolation in FIG. 3, may have any suitable shape and/or structure for moving within the central passage 108 of the valve 102. For example, referring to FIG. 2 and FIG. 3, the plunger 132 may have an outer body 138 that at least partially surrounds a plunger core 158. The outer body 138 may slidably engage an inner wall 160 of the valve body 114 (which may be formed by the sleeve 130 between the solenoid 120 and the central passage 108), and the plunger core 158 may be fixed relative to the outer body 138 such that when the outer body 138 moves relative to the valve body 114, the plunger core 158 also moves within the central passage 108.

To facilitate fluid communication between opposite sides of the plunger 132 when the valve is open, a set of channels 162 is included. The channels 162 are located between the outer body 138 and the plunger core 158, as shown. While the channels 162 may have any suitable shape, they are included as cylindrical channels in the depicted embodiment (which may simplify manufacturing). Thus, when the valve is open, fluid may flow from the inlet 110 to the outlet 112.

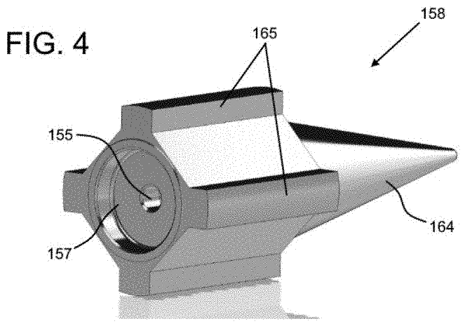

The plunger core 158, shown in isolation in FIG. 4, may also include a unique shape. For example, as shown in FIG. 2 and FIG. 4, the plunger core 158 may include a conical structure 164 having a relatively small diameter on its side closer to the inlet 110. Such a structure may be advantageous for decreasing friction within the valve 102 (e.g., perhaps causing a desirable laminar flow), reducing the noise created by the valve 102, reducing internal stress experienced by the plunger 132 and/or valve body 114 during operation, etc. A set of protrusions 165 may be included, which may contact an inner diameter wall of the above-described outer body 138 of the plunger 132 (see FIG. 3). The protrusions 165 may be configured (e.g., sized, shaped, and positioned) to form the channels 162 (FIG. 3) allowing through-flow of a fluid when the valve is open, for example. A cavity 155 may be included for engaging the pin 154 for attachment of a seal 148, as discussed above (see FIG. 3). Additionally or alternatively, a second cavity 157, depression, or other suitable structure may be included for receiving the above-described seal 148 such that the seal 148 remains in an appropriate position during valve operation.

While various embodiments of the present disclosure have been described, the present disclosure is not to be restricted except in light of the attached claims and their equivalents. One skilled in the relevant art will recognize that numerous variations and modifications may be made to the embodiments described above without departing from the scope of the present invention, as defined by the appended claims. Moreover, the advantages described herein are not necessarily the only advantages of the present disclosure and it is not necessarily expected that every embodiment of the present disclosure will achieve all of the advantages described.

Without limitation, the subject matter of this disclosure may also relate to one or more of the following aspects (and combinations thereof):

One general aspect includes a valve, including: an inlet; an outlet; a plunger located at least partially within a central passage of the valve, where the plunger is movable between an open state and a closed state, and where the inlet is in fluid communication with the outlet when the plunger is in the open state, and where the plunger prevents fluid communication between the inlet and the outlet when the plunger is in the closed state; and a solenoid having a winding that surrounds the central passage of the valve and at least partially surrounds the plunger, and where the solenoid is configured to move the plunger between the open state and the closed state.

Certain implementations may include one or more of the following advantageous features. For example, a spring may be coupled to the plunger and causes the plunger to move into at least one of the open state and the closed state when the solenoid is off. The spring may include a washer spring located between a first spring surface fixed to at least one of the inlet and the outlet and a second spring surface fixed to the plunger. When solenoid is on, the solenoid may overcome a spring force caused by the spring such that the plunger moves from the open state to the closed state. When the solenoid is on, the solenoid may overcome a spring force caused by the spring such that the plunger moves from the closed state to the open state. The valve may further include a compliant seal and a seat surface for contacting the compliant seal, where the compliant seal is secured to the plunger and where the seat surface is fixed relative to at least one of the inlet and the outlet. A pin may secure the compliant seal to the plunger. If a compliant seal is included, the valve may have a seat surface for contacting the compliant seal, where the seat surface is fixed relative to the plunger and where the plunger is moveable relative to the compliant seal. The plunger may have an outer plunger body and a plunger core, where the outer plunger body at least partially surrounds the plunger core, and where at least one channel is located between the outer plunger body and the plunger core. The outer plunger body may include a magnetizable material that experiences a linear force when the winding of the solenoid receives a current. The plunger core may include a conical structure having a relatively small diameter on a side closer to the inlet.

Another general aspect includes a valve, including: an inlet; an outlet; a plunger located at least partially within a central passage of the valve, where the plunger is movable between an open state and a closed state, and where the inlet is in fluid communication with the outlet when the plunger is in the open state, and where the plunger prevents fluid communication between the inlet and the outlet when the plunger is in the closed state; and a solenoid having a winding that surrounds the central passage of the valve and at least partially surrounds the plunger, where the plunger includes a magnetizable material that experiences a linear force extending along the central passage of the valve when the winding of the solenoid receives a current. Implementations may include any of the features described above, where compatible.

Another general aspect includes a plunger for a valve, including: an outer body portion including a magnetizable material; and a plunger core configured to move within a central passage of a valve between an open state and a closed state, where the plunger core is fixed relative to the outer body portion. Implementations may include any of the features described above, where compatible.

We claim:

1. A valve, comprising:
an inlet;
an outlet;
a plunger located at least partially within a central passage of the valve, wherein the plunger is movable between an open state and a closed state, and wherein the inlet is in fluid communication with the outlet when the plunger is in the open state, and wherein the plunger prevents fluid communication between the inlet and the outlet when the plunger is in the closed state; and
a solenoid having a winding that surrounds the central passage of the valve and at least partially surrounds the plunger, and wherein the solenoid is configured to move the plunger between the open state and the closed state.

2. The valve of claim 1, wherein a spring is coupled to the plunger and causes the plunger to move into at least one of the open state and the closed state when the solenoid is off.

3. The valve of claim 2, wherein the spring includes a washer spring located between a first spring surface fixed to at least one of the inlet and the outlet and a second spring surface fixed to the plunger.

4. The valve of claim 2, wherein when the solenoid is on, the solenoid overcomes a spring force caused by the spring such that the plunger moves from the open state to the closed state.

5. The valve of claim 2, wherein the solenoid is on, the solenoid overcomes a spring force caused by the spring such that the plunger moves from the closed state to the open state.

6. The valve of claim 1, further comprising a compliant seal and a seat surface for contacting the compliant seal, wherein the compliant seal is secured to the plunger and wherein the seat surface is fixed relative to at least one of the inlet and the outlet.

7. The valve of claim 6, wherein a pin secures the compliant seal to the plunger.

8. The valve of claim 1, further comprising a compliant seal and a seat surface for contacting the compliant seal, wherein the seat surface is fixed relative to the plunger and wherein the plunger is moveable relative to the compliant seal.

9. The valve of claim 1, wherein the plunger includes an outer plunger body and a plunger core, wherein the outer plunger body at least partially surrounds the plunger core, and wherein at least one channel is located between the outer plunger body and the plunger core.

10. The valve of claim 9, wherein the outer plunger body includes a magnetizable material that experiences a linear force when the winding of the solenoid receives a current.

11. The valve of claim 9, wherein the plunger core includes a conical structure having a relatively small diameter on a side closer to the inlet.

12. A valve, comprising:
an inlet;
an outlet;
a plunger located at least partially within a central passage of the valve, wherein the plunger is movable between an open state and a closed state, and wherein the inlet is in fluid communication with the outlet when the plunger is in the open state, and wherein the plunger prevents fluid communication between the inlet and the outlet when the plunger is in the closed state; and
a solenoid having a winding that surrounds the central passage of the valve and at least partially surrounds the plunger,
wherein the plunger includes a magnetizable material that experiences a linear force extending along the central passage of the valve when the winding of the solenoid receives a current.

13. The valve of claim 12, wherein a spring is coupled to the plunger and causes the plunger to move into at least one of the open state and the closed state when the solenoid is off.

14. The valve of claim 13, wherein the spring includes a washer spring located between a first spring surface fixed to at least one of the inlet and the outlet and a second spring surface fixed to the plunger.

15. The valve of claim 13, wherein when the solenoid is on, the solenoid overcomes a spring force caused by the spring such that the plunger moves from the open state to the closed state.

16. The valve of claim 13, wherein the solenoid is on, the solenoid overcomes a spring force caused by the spring such that the plunger moves from the closed state to the open state.

17. The valve of claim 12, further comprising a compliant seal and a seat surface for contacting the compliant seal, wherein the compliant seal is secured to the plunger and wherein the seat surface is fixed relative to at least one of the inlet and the outlet.

18. A plunger for a valve, comprising:
an outer body portion including a magnetizable material; and
a plunger core configured to move within a central passage of a valve between an open state and a closed state,
wherein the plunger core is fixed relative to the outer body portion.

19. The plunger of claim 18, wherein the outer plunger body at least partially surrounds the plunger core, and wherein at least one channel is located between the outer body portion and the plunger core.

20. The plunger of claim 18, wherein the plunger core is secured to a compliant seal that contacts a seat surface of a valve body when the plunger is in the closed state.
